(19) United States
(12) Patent Application Publication
(10) Pub. No.: US 2006/0103736 A1
(43) Pub. Date: May 18, 2006

(54) Sequential processing of video data

(76) Inventor: Pere Obrador, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/987,259

(22) Filed: Nov. 12, 2004

(51) Int. Cl. H04N 5/228

(52) U.S. Cl. 348/222.1

(57) ABSTRACT

In one aspect, multiresolution data pyramids are generated. Each multiresolution data pyramid includes representations of an associated video frame at different respective spatial resolution levels. Each multiresolution data pyramid is stored in a respective discrete frame packet. Each frame packet is processed through a sequence of frame packet processing stages generating data that is stored in the corresponding frame packet. In another aspect, the multiresolution data pyramids are processed through a sequence of processing stages. Each processing stage performs one or more processes operating at respective variable spatial resolution levels of the multiresolution data pyramids. The respective spatial resolution levels at which each process operates are selected.

### BACKGROUND

Individuals and organizations are rapidly accumulating large collections of video content. As these collections grow in number, individuals and organizations increasingly will require systems and methods for organizing and browsing the video content in their collections. To meet this need, a variety of different approaches for organizing and browsing video content have been proposed. Many of these approaches include video enrichment tools that automatically generate searchable meta-data summarizing the video data or describing attributes of the video data. Exemplary video enrichment tools include key-frame extraction tools, face detection tools, and video indexing tools. Many video enrichment tools are implemented as offline software applications that operate on video content after it has been captured and stored in a compressed video file.

Real-time video processing systems that process video streams at video rates have been developed. Many of these systems include a pipelined architecture that includes hardware for performing low-level front-end operations on the video data and hardware or firmware for performing higher-level operations on the results of the front-end operations. A common front-end operation involves decomposing an original video frame into a multiresolution image pyramid consisting of a set of representations of the video frame at successively lower spatial resolution.

One general purpose computing engine for real-time vision applications purportedly provides real-time image stabilization, motion tracking, change detection, stereo vision, fast search for objects of interest in a scene, and robotic guidance. The computing engine purportedly focuses on critical elements of each scene using a pyramid filtering technique in accordance with which initial processing is performed at reduced resolution and sample density and subsequent processing is progressively refined at higher resolutions as needed. The computing engine performs pipeline processing as image data flows through a sequence of processing elements. The data flow paths and processing elements of the computing engine, however, must be reconfigured to perform different tasks. Once configured, a sequence of steps is performed for an entire image or a sequence of images without external control. The computing engine, however, is not modular and cannot be scaled smoothly from a system with relatively modest hardware resources to a system with significantly more hardware resources.

A modular, real-time video processing system has been proposed that purportedly can be scaled smoothly from relatively small systems with modest amounts of hardware to very large, very powerful systems with significantly more hardware. The system requires multiples of basic video processing elements for performing front-end video processing operations and one or more processing modules with parallel pipelined video hardware that is programmable to provide different video processing operations on an input stream of video data. All video hardware in the system operates on video streams in a parallel pipelined fashion, whereby video data is read out of frame stores one pixel at a time. Video streams are transferred in a standardized video format in which each pixel has eight bits of active video data and two timing signals that frame the active video data by indicating areas of horizontal and vertical active data.

The above-described real-time video processing systems are suitable for implementation as specialized video processing boards for computers and workstations. These systems, however, are not suitable for integration into video cameras and other hand held computing environments, where signal and power constraints are significant.

### SUMMARY

In one aspect, the invention features a method of processing video data. In accordance with this inventive method, multiresolution data pyramids are generated. Each multiresolution data pyramid includes representations of an associated video frame at different respective spatial resolution levels. Each multiresolution data pyramid is stored in a respective discrete frame packet. Each frame packet is processed through a sequence of frame packet processing stages generating data that is stored in the corresponding frame packet.

In another aspect, the invention features a video camera that comprises a processing stage that generates multiresolution data pyramids. Each multiresolution data pyramid includes representations of an associated video frame at different respective spatial resolution levels. The processing stage stores each multiresolution data pyramid in a respective discrete frame packet. The video camera includes a sequence of frame packet processing stages that processes each frame packet and generates data that is stored in the corresponding frame packet.

In another aspect, the invention features a method of processing video data. In accordance with this inventive method multiresolution data pyramids are generated. Each multiresolution data pyramid includes representations of an associated video frame at different respective spatial resolution levels. The multiresolution data pyramids are processed through a sequence of processing stages. Each processing stage performs one or more processes operating at respective variable spatial resolution levels of the multiresolution data pyramids. The respective spatial resolution levels at which each process operates are selected.

In another aspect, the invention features a video camera that comprises a processing stage that generates multiresolution data pyramids. Each multiresolution data pyramid includes representations of an associated video frame at different respective spatial resolution levels. The video camera includes a sequence of processing stages each performing one or more processes operating at respective variable spatial resolution levels of the multiresolution data pyramids. The video camera includes a controller that selects the respective spatial resolution levels at which each process operates.

Other features and advantages of the invention will become apparent from the following description, including the drawings and the claims.

### DESCRIPTION OF DRAWINGS

FIG. 1 is a block diagram of an embodiment of a video camera that includes a lens, an image sensor system, a preprocessing module, a post-processing module, and a storage device.

FIG. 2 is a flow diagram of an embodiment of a method of processing video data.

FIG. 3 is a block diagram of an embodiment of a frame packet and the data stored in the frame packet.

FIG. 4 is a diagrammatic view of an implementation of the post-processing module of FIG. 1 having a sequence of processors each executing a respective set of processes that operate on frame packets traversing a serial data flow path.

FIG. 5 is a block diagram of an implementation of the post-processing module of FIG. 1.

FIG. 6 shows a sequence of four frame packets that are processed by a sequence of three processes in an implementation of the post-processing module of FIG. 1.

FIG. 7 is a flow diagram of an embodiment of a method of processing video data.

FIG. 8 is a diagrammatic view of an embodiment of a load-balancing specification.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

The video processing embodiments described in detail below provide a serial video processing pipeline that may be readily integrated into video cameras and other hand-held computing environments, as well as in higher-performance computing systems and devices. In some implementations, data needed for processing a video frame is encapsulated in a frame packet data structure that allows the sequential processing stages to operate independently of one another. The frame packet data structure thereby enables the video processing embodiments described herein to scale with available processing resources.

In some implementations, video data is sequentially processed in ways that enable multiple video enrichment processes to be performed at different respective performance levels. These processes may be load-balanced to accommodate specified preferences with the constraints of available processing resources. These implementations are able to accommodate a wide variety of different video enrichment priorities, while gracefully adapting to a wide range of processing environments ranging from devices, such as video cameras, that have limited processing resources to large computing systems that have vast processing resources.

I. OVERVIEW

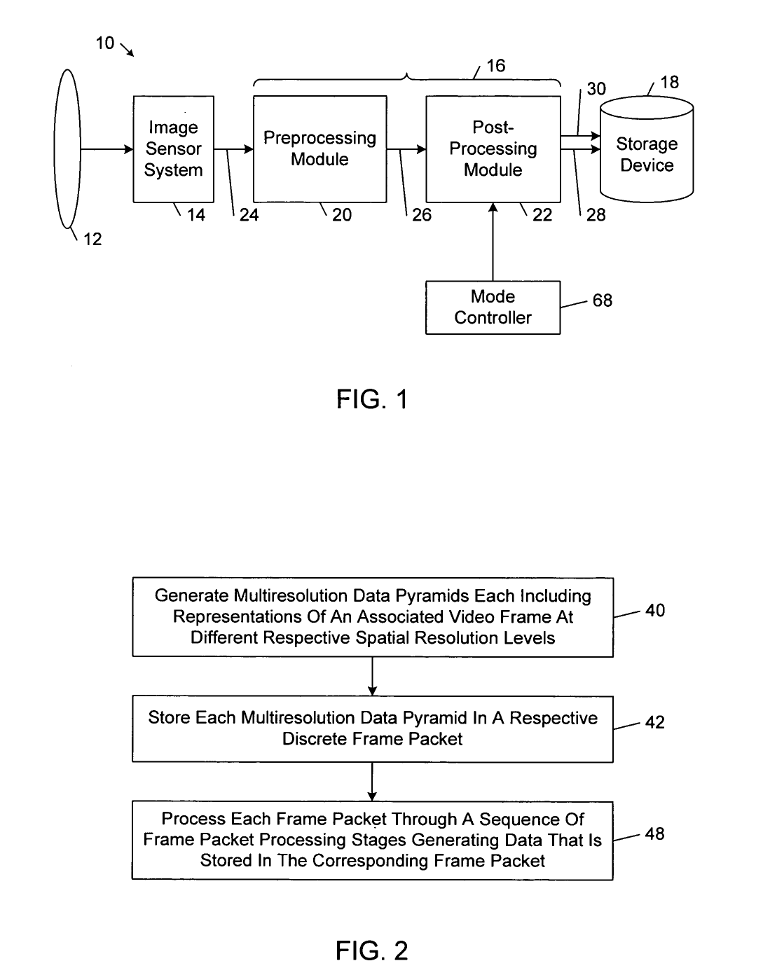

FIG. 1 shows an embodiment of a video camera 10 that includes a lens 12, an image sensor system 14, a video processing pipeline 16, and a storage device 18. The image sensor system 14 includes one or more image sensors (e.g., a charge coupled device (CCD) or a complementary metal-oxide-semiconductor (CMOS) image sensor). The video processing pipeline 16 is implemented by a combination of hardware and firmware components. In the illustrated embodiment, the video processing pipeline 16 includes a preprocessing module 20 and a post-processing module 22. The distinction between the preprocessing module 20 and the post-processing module 22, however, is largely conceptual and is not necessarily reflected in an actual implementation of the video processing pipeline 16. The storage device 18 may be implemented by any type of video storage technology, including a compact flash memory card and a digital video tape cassette. The video data stored in storage device 18 may be transferred to a storage device (e.g., a hard disk drive, a floppy disk drive, a CD-ROM drive, or a non-volatile data storage device) of an external processing system (e.g., a computer or workstation).

In operation, light from an object or a scene is focused by lens 12 onto an image sensor of image sensor system 14. Image sensor system 14 converts raw image data into video frames 24 at a rate of, for example, thirty frames per second. The preprocessing module 20 performs a set of front-end operations on the video frames 24, including down-sampling, video demosaicing, color-correcting, and generating multiresolution data pyramids. As explained in detail below, the results of the front-end operations are stored in discrete data structures referred to herein as “frame packets” 26. Each frame packet 26 stores the multiresolution data pyramid image data, intermediate processing data, and meta-data associated with a respective video frame 24.

The post-processing module 22 generates compressed video frames 28 from the video data contained in the frame packets 26 in accordance with a video compression process (e.g., MPEG or motion-JPEG). The compressed video frames 28 are stored in the storage device 18 in the form of one or more discrete video files.

The post-processing module 22 also generates meta-data 30 that is stored in the storage device 18 together with the compressed video frames 28. In some implementations, the meta-data 30 is stored in a header location of the stored video files or in separate adjacent files linked to the video files. The meta-data 30 provides information about or documentation of the video data stored in the storage device 18, including descriptive information about the context, quality, condition, or characteristics of the video data. For example, the meta-data 30 may document data about video data elements or attributes, data about video files or data structures that are stored in the storage device 18, and data about other meta-data. The meta-data 30 enrich the video data that is stored in the storage device 18. The meta-data 30 may be used by suitably-configured tools for searching, browsing, editing, organizing, and managing collections of one or more video files captured by the video camera 10.

II. Frame Packet Based Processing of Video Data

FIG. 2 shows an embodiment of a method by which the video processing pipeline 16 of the video camera 10 processes video data.

In accordance with this method, the preprocessing module 20 generates multiresolution data pyramids from the video frames 24 that are received from the image sensor system 14 (block 40). Each multiresolution data pyramid includes representations of an associated video frame 24 at different respective spatial resolution levels. In some implementations, the multiresolution data pyramids are generated by iteratively filtering the associated video frames 24 and sub-sampling the filtered results. The multiresolution data pyramids may correspond to any type of image pyramids, including Gaussian pyramids and Laplacian pyramids. In general, a multiresolution data pyramid is a collection of representations of an image at different spatial resolution levels. Each level in a typical multiresolution data pyramid is one-quarter of the size of previous level.

The lowest level of a multiresolution data pyramid has the highest spatial resolution and the highest level of a multiresolution data pyramid has the lowest spatial resolution. The filtering type (e.g., Gaussian, Laplacian, or averaging) and down-sampling factor from one level of the multiresolution data pyramid to the next are configurable parameters of the preprocessing module 20.

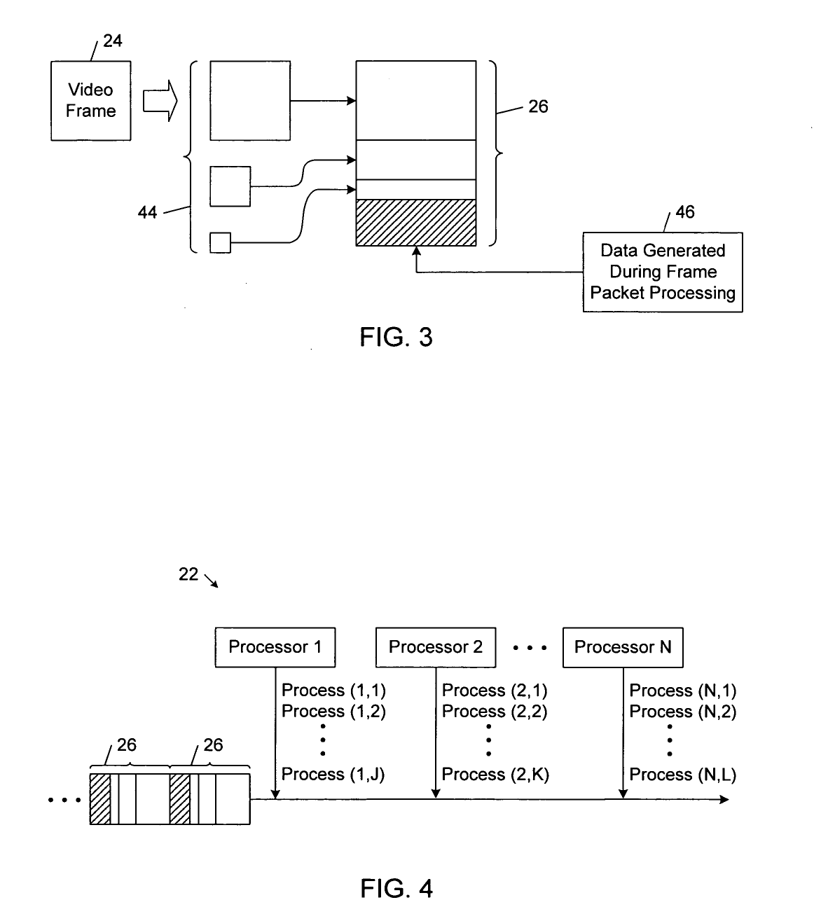

The preprocessing module 20 stores each multiresolution data pyramid in a respective discrete frame packet 26 (block 42). FIG. 3 shows a video frame 24 decomposed into a multiresolution data pyramid 44 and an embodiment of a frame packet 26 storing the image data of the multiresolution data pyramid 44.

The frame packet 26 also includes an area for storing data 46 that is generated during the processing of the frame packet in the post-processing module 22. This data includes intermediate processing data (e.g., variables that are used by one or more processes that are executed in the post-processing module) and meta-data 30. The frame packet data structure includes specific memory addresses for respectively holding all of the meta-data that are generated by the post-processing module 22. This feature increases the memory management efficiency and the computational efficiency of the video processing pipeline 16.

In the post-processing module 22, each frame packet 26 is processed through a sequence of frame packet processing stages (block 48). The frame packet processing stages generate the data 46 that is stored in the corresponding frame packets 26.

FIG. 4 shows an embodiment of the post-processing module 22 that includes a sequence of N processors (Processor 1, Processor 2, . . . , Processor N). Each processor corresponds to a respective stage of the post-processing module 22. In general, each processor executes a respective set of one or more processes.

In the illustrated embodiment, Processor 1 executes Process (1,1), Process (1,2), . . . Process (1,J); Processor 2 executes Process (2,1), Process (2,2), . . . , Process (2,K); and Process N executes Process (N,1), Process (N,2), . . . , Process (N,L). The frame packets 26 are processes through one frame packet processing stage to another along a serial data flow path. Each process that is executed in a frame packet processing stage operates on one frame packet 26 at a time. During execution, a process may generate meta-data 30 or intermediate processing data or both. This data is stored in the current frame packet 26 being processed.

The intermediate processing data generated in a given frame packet processing stage may be used by one or more processes that are executed in the same frame packet processing stage. The intermediate processing data also may be used by one or more processes that are executed in one or more succeeding frame packet processing stages in the sequence. In some implementations, one or more of the processes executed in the post-processing module 22 are operable to determine whether a current frame packet 26 contains any intermediate processing data that is needed or may be used for processing the video data. The needed intermediate processing data includes data computed at the current spatial resolution level designated for a given process and data computed at a spatial resolution level different from the spatial resolution level designated for the given process. The given process may use data computed at a lower spatial resolution level (higher level of the multiresolution data pyramids), for example, as the starting point for computing data at the designated spatial resolution level.

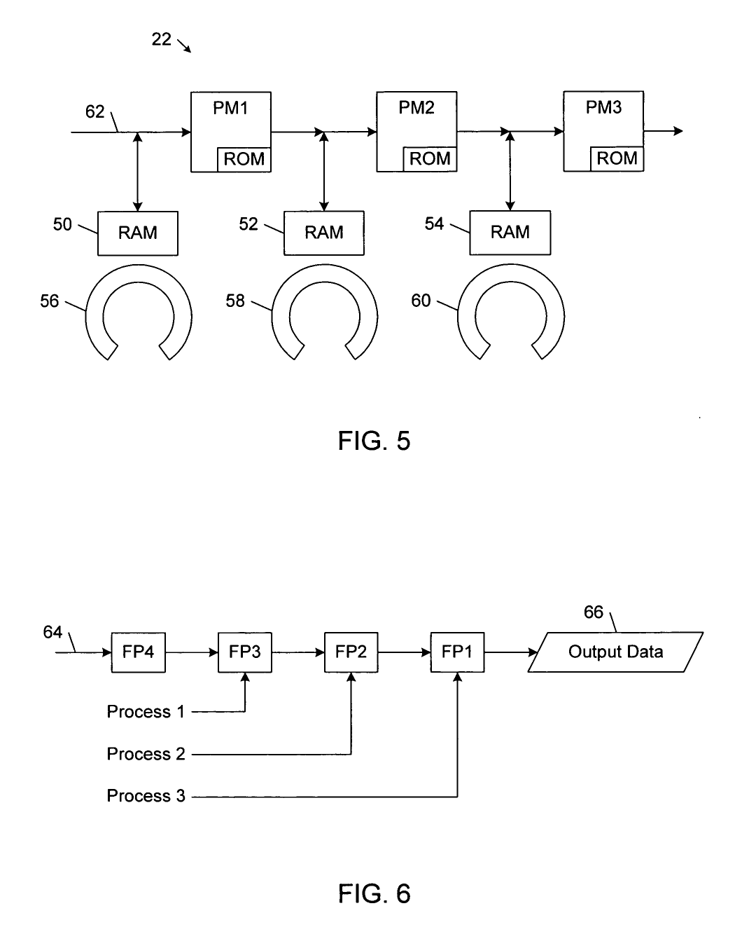

FIG. 5 shows an implementation of the post-processing module 22 that includes three processing modules (PM1, PM2, PM3), three random access memories 50, 52, 54, three circular frame buffers 56, 58, 60, and a data bus 62. Each of the processing modules includes at least one respective digital signal processor or other processing unit and corresponds to a respective stage of the post-processing module 22. The random access memories 50-54 may be implemented as separate units, as shown in FIG. 5, or they may be integrated onto the corresponding processing modules. Each circular frame buffer 56-60 has sufficient memory to hold multiple frame packets 26. As the frame packets 26 are loaded into the circular frame buffers 56-60, the digital signal processors in the processing modules automatically generate and increment pointers for memory accesses to the circular frame buffers 56-60. These accesses wrap to the beginning of the circular frame buffers 56-60 when their ends are reached.

In operation, frame packets 26 are loaded into circular frame buffer 56 in a FIFO fashion. Processing module PM1 executes one or more processes that operate on one or more frame packets 26 stored in the circular buffer 56. Any intermediate processing data and any meta-data that is generated by the processes executed by processing module PM1 are stored in the corresponding frame packets 26. After a frame packet 26 has reached the end of the frame buffer 56, the frame packet 26 is transferred to the beginning of frame buffer 58, where the frame packet 26 is operated on by one or more processes being executed by processing module PM2. Any intermediate processing data and any meta-data that is generated by the processes executed by processing module PM2 are stored in the corresponding frame packets 26. After a frame packet 26 has reached the end of the frame buffer 58, the frame packet 26 is transferred to the beginning of frame buffer 60, where the frame packet 26 is operated on by one or more processes being executed by processing module PM3.

The scalability of the implementation of the post-processing module 22 shown in FIG. 5 is apparent. Adding one more processing module allows processes to operate on frame packets at a lower level (i.e., higher spatial resolution) of the multiresolution data pyramids, optimizing the overall video enrichment results.

FIG. 6 shows one exemplary illustration of the operation of post-processing module 16. In this example, a sequence of four frame packets (FP1, FP2, FP3, and FP4) are processed by a sequence of three processes (Process 1, Process 2, and Process 3) that are respectively executed by the processing modules PM1, PM2, and PM3 shown in FIG. 5. The frame packets traverse a serial data flow path 64, whereby they are processed sequentially by Process 1, Process 2, and Process 3. Thus, at the instant of time shown in FIG. 6: Process 3 is operating on frame packet FP1, which has already been processed by Processes 1-2; Process 2 is operating on frame packet FP2, which has already been processed by Process 1; Process 1 is operating on frame packet FP3; and frame packet FP4 has yet to be processed by any of Process 1, Process 2, and Process 3. At the next processing iteration: Process 3 will be operating on frame packet FP2, which has already been processed by Processes 1-2; Process 2 will be operating on frame packet FP3, which has already been processed by Process 1; and Process 1 will be operating on frame packet FP4.

In some implementations of the post-processing module 22, the final process (i.e., Process 3 in FIG. 6) corresponds to a video compression process (e.g., an MPEG or MJPEG video compression process). The output data 66 of the video compression process includes a compressed video frame and any meta-data that has been generated by the processes that were executed in the post-processing module 22. The output data 66 is stored in the storage device 18. Any intermediate processing data that was generated by the processes that were executed in the post-processing module 22 is discarded.

III. Allocating Processing Resources to Processes

Referring back to FIG. 1, the video camera 10 includes a mode controller 68 that allows a user to prioritize the video enrichment meta-data 30 that is generated by the post-processing module 22. For example, an implementation of the video camera 10 may include several video enrichment modes, such as a video indexing mode and a video advisor mode. A user who is more interested in using the video indexing video enrichment output would set the mode controller 68 to place the video camera 10 in the video indexing mode of operation, whereas a user who is more interested in using the video advisor video enrichment output would set the mode controller 68 to place the video camera 10 in the video advisor mode of operation.

The video indexing mode may generate meta-data 30 that enables a video file to be divided hierarchically into shots (a continuous sequence of frames), scenes (one or more shots that present different views of the same event), and segments (one or more related scenes). The video indexing mode may involve the execution of one or more video analysis processes that automatically extract structure and meaning from visual cues in a sequence of video frames. Among the processes that may be executed in a video indexing mode of operation are: key-frame extraction, shot boundary detection, scene clustering, object detection, object movement analysis, human-face detection, speech analysis, and optical character recognition.

The video advisor mode may generate meta-data 30 that enables users to assess the quality of the video content in their collections. For example, the video advisor mode may generate meta-data 30 the enables shots to be ranked from best to worst and that characterizes shots in terms of various attributes. The video advisor mode may involve the execution of one or more video analysis processes that automatically extract information relating to the quality of frames or shots in a video file. Among the processes that may be executed in a video advisor mode of operation are: camera movement analysis, and low-level information extraction, such as, focus detection, color information extraction, shape information extraction, and texture information extraction.

During video capture, the mode controller 32 allocates the processing resources of the post-processing module 22 to processes in accordance with the operational mode specified by the user. For example, in some implementations, the mode controller 32 sets the processes corresponding to the selected operational mode to operate on the video data at the highest resolution level; any remaining processing resources are allocated to processes relating to the unselected operational modes. In this way, the video camera 10 provides high quality video enrichment meta-data enabling the functionality of more interest to the user, while still providing video enrichment meta-data (albeit of lower quality) enabling other functionalities.

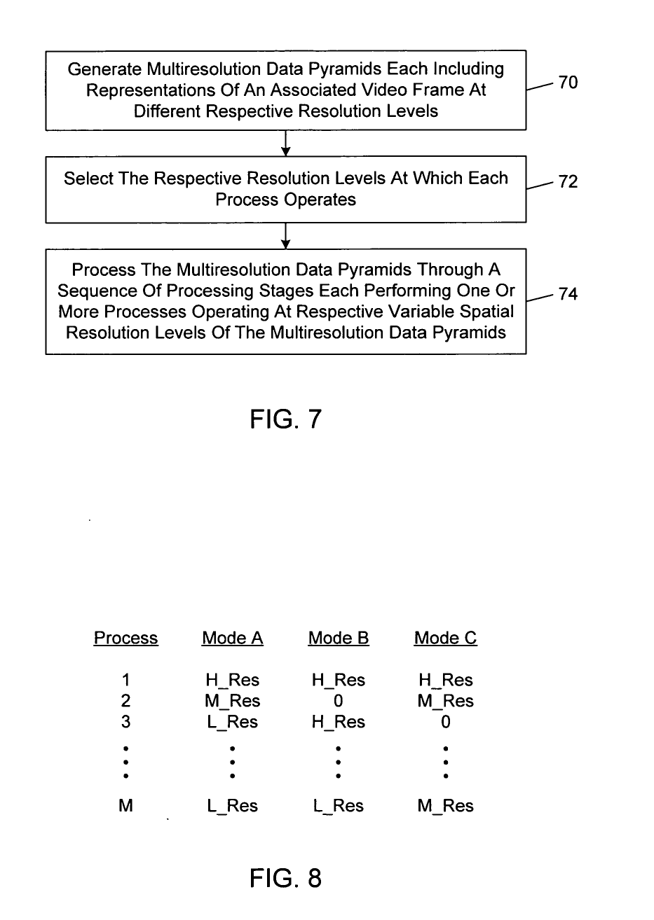

FIG. 7 shows an embodiment of a method of processing video data in a way that enables processing resources to be allocated to processes in accordance with the availability of processing resources and user-specified preferences.

In accordance with this method, the preprocessing module 20 generates multiresolution data pyramids from the video frames 24 received from the image sensor system 14 (block 70). Each multiresolution data pyramid includes representations of an associated video frame 24 at different respective spatial resolution levels. In some implementations, the multiresolution data pyramids are generated by iteratively filtering the associated video frames 24 and sub-sampling the filtered results. The multiresolution data pyramids may correspond to any type of image pyramids, including Gaussian pyramids and Laplacian pyramids. In general, a multiresolution data pyramid is a collection of representations of an image at different spatial resolution levels. Each level in a typical multiresolution data pyramid is one-quarter of the size of previous level. The lowest level of a multiresolution data pyramid has the highest spatial resolution and the highest level of a multiresolution data pyramid has the spatial lowest resolution.

The respective resolution levels at which each process operates is selected (block 72). In some implementations, the mode controller 68 sets the spatial resolution levels of the processes through load-balancing specifications stored as respective lookup tables in read-only memories associated with the processing elements of the post-processing module 22. The resource allocation specification may indicate a spatial resolution level for each process for each operational mode selectable by a user.

The post-processing module 22 processes the multiresolution data pyramids through a sequence of processing stages (block 74). Each processing stage performs one or more processes operating at respective variable spatial resolution levels of the multiresolution data pyramids. In particular, each process may be selectively configured to operate on the video frame representation in the multiresolution data pyramids corresponding to a designated spatial resolution level.

Depending on the operational mode of the video camera 10, some of the processes may be devoted more processing power so that these processes to operate at a lower level (i.e., higher spatial resolution level) of the multiresolution data pyramids, whereas other processes are devoted less processing power so that they operate at a higher level (i.e., lower spatial resolution level) of the multiresolution data pyramids. If sufficient processing resources are available, all processes may operate at the lowest level (i.e., highest spatial resolution) of the multiresolution data pyramids. If sufficient resources are not available, however, the available processing resources may be allocated in accordance with a predefined resource allocation specification. When a user specifies a different video camera operational mode, the load may be balanced to a different set of processes, without losing the full functionality of the previously preferred set of processes. In this way, all or most of the video enrichment functionalities of the video camera 10 can be provided, although the video enrichment results may degrade gracefully depending on the operational mode and the available processing resources.

FIG. 8 shows an exemplary lookup table for a load-balancing specification for a given frame packet processing stage of the post-processing module 22. The lookup table contains a list of M processes (Process 1, Process 2, Process 3, . . . , Process M) and a set of spatial resolution levels for each of three operational modes (Mode A, Mode B, Mode C). For operational Mode A, Process 1 would operate at a high spatial resolution level (H_res), Process 2 would operate at a medium spatial resolution level (M_Res), and Processes 3 and M would operate at a low spatial resolution level (L_res). For operational Mode B, Processes 1 and 3 would operate at a high spatial resolution level (H_res), Process 2 would not be executed, and Process M would operate at a low spatial resolution level (L_Res). For operational Mode C, Process 1 would operate at a high spatial resolution level (H_res), Processes 2 and M would operate at a medium spatial resolution level (M_Res), and Process 3 would not be executed.

The spatial resolution level designated for a given process listed in the lookup table shown in FIG. 8 maps to a proportion of processing time that is allocated to a given process. Thus, for each operational mode, the load-balancing specification in effect allocates the processing resources of a given frame packet processing stage of post-processing module 22 to the processes executed by the given frame packet processing stage.

Other embodiments are within the scope of the claims.

For example, the video camera embodiment shown in FIG. 1 contains only a single video processing pipeline 16. Other embodiments, however, may include additional hardware pipelines, including a separate still image processing pipeline. In still other embodiments, the video processing pipeline 16 may be configured to concurrently process video frames and high-resolution still images.

What is claimed is:

1. A method of processing video data, comprising:
generating multiresolution data pyramids each including representations of an associated video frame at different respective spatial resolution levels;
storing each multiresolution data pyramid in a respective discrete frame packet; and
processing each frame packet through a sequence of frame packet processing stages generating data that is stored in the corresponding frame packet.

2. The method of claim 1, wherein the data generated by a preceding frame packet processing stage includes intermediate processing data that is stored in the corresponding frame packet for use by at least one subsequent frame packet processing stage.

3. The method of claim 1, further comprising determining whether a frame packet contains intermediate processing data usable by a process performed during a respective one of the processing stages.

4. The method of claim 1, further comprising generating respective meta-data during at least one frame packet processing stage.

5. The method of claim 4, further comprising storing the meta-data in respective frame packets associated with the corresponding video frames.

6. The method of claim 4, wherein the meta-data enables at least one video enrichment functionality selected from: summarizing the video data, content-based search/retrieval of the video data, and managing the video data.

7. The method of claim 1, further comprising performing during at least one frame packet processing stage at least one process selected from: key-frame extraction; video indexing; shot detection; face detection; focus detection; color information extraction; motion information extraction; shape information extraction; and texture information extraction.

8. The method of claim 1, further comprising generating compressed video frames from frame packets during at least one frame packet processing stage.

9. The method of claim 1, wherein each frame packet processing stage performs one or more processes operating at respective variable spatial resolution levels of the multiresolution data pyramids.

10. The method of claim 9, further comprising selecting the respective spatial resolution levels at which each process operates.

11. The method of claim 10, wherein selecting the respective spatial resolution levels comprises determining an operational mode prioritizing at least one video enrichment output from the processing of each frame packet.

12. The method of claim 11, wherein selecting the respective spatial resolution levels comprises reading a load-balancing specification corresponding to the operational mode.

13. The method of claim 1, further comprising allocating processing resources to processes performed during the processing stages.

14. The method of claim 13, wherein the processing resources are allocated based on an operational mode prioritizing at least one video enrichment output from the processing of each frame packet.

15. A video camera, comprising:
a processing stage generating multiresolution data pyramids each including representations of an associated video frame at different respective spatial resolution levels and storing each multiresolution data pyramid in a respective discrete frame packet; and
a sequence of frame packet processing stages processing each frame packet and generating data that is stored in the corresponding frame packet.

16. The video camera of claim 15, wherein data generated by a preceding frame packet processing stage includes intermediate processing data that is stored in the corresponding frame packet for use by at least one subsequent frame packet processing stage

17. The video camera of claim 15, wherein at least one frame packet processing stage determines whether a frame packet contains intermediate processing data usable by a process performed by the at least one frame packet processing stage.

18. The video camera of claim 15, wherein at least one frame packet processing stage generates respective meta-data.

19. The video camera of claim 18, wherein the at least one frame packet processing stage stores the meta-data in respective frame packets associated with the corresponding video frames.

20. The video camera of claim 18, wherein the meta-data enables at least one video enrichment functionality selected from: summarizing the video data, content-based search/retrieval of the video data, and managing the video data.

21. The video camera of claim 15, wherein at least one frame packet processing stage performs at least one process selected from: key-frame extraction; video indexing; shot detection; face detection; focus detection; color information extraction; motion information extraction; shape information extraction; and texture information extraction.

22. The video camera of claim 15, wherein at least one frame packet processing stage generates compressed video frames from frame packets.

23. The video camera of claim 15, wherein each processing stage performs one or more processes operating at respective spatial resolution levels of the multiresolution data pyramids.

24. The video camera of claim 23, further comprising a controller selecting the respective spatial resolution levels at which each process operates.

25. The video camera of claim 24, wherein the controller selects the respective spatial resolution levels based on a determination of an operational mode prioritizing at least one video enrichment output from the processing of each frame packet.

26. The video camera of claim 25, wherein the controller reads a load-balancing specification corresponding to the operational mode.

27. The video camera of claim 15, wherein the controller allocates processing resources to processes performed during the frame packet processing stages.

28. The video camera of claim 27, wherein the controller allocates the processing resources based on an operational mode prioritizing at least one video enrichment output from the processing of each frame packet.

29. A method of processing video data, comprising:
generating multiresolution data pyramids each including representations of an associated video frame at different respective spatial resolution levels;
processing the multiresolution data pyramids through a sequence of processing stages each performing one or more processes operating at respective variable spatial resolution levels of the multiresolution data pyramids; and
selecting the respective spatial resolution levels at which each process operates.

30. The method of claim 29, wherein selecting the respective spatial resolution levels comprises determining an operational mode prioritizing at least one video enrichment output from the processing of each frame packet.

31. The method of claim 30, further comprising allocating processing resources to the processes based on the operational mode.

32. The method of claim 31, wherein selecting the respective spatial resolution levels comprises reading a load balancing specification corresponding to the operational mode.

33. A video camera, comprising:
a processing stage generating multiresolution data pyramids each including representations of an associated video frame at different respective spatial resolution levels;
a sequence of processing stages each performing one or more processes operating at respective variable spatial resolution levels of the multiresolution data pyramids; and
a controller selecting the respective spatial resolution levels at which each process operates.

34. The video camera of claim 33, wherein the controller selects the respective spatial resolution levels based on a determination of an operational mode prioritizing at least one video enrichment output produced by the processing of the multiresolution data pyramids.

35. The video camera of claim 34, wherein the controller allocates processing resources to the processes based on the operational mode.

36. The video camera of claim 35, wherein the controller reads a load balancing specification corresponding to the operational mode.
